(19) United States
(12) Patent Application Publication
(10) Pub. No.: US 2026/0358793 A1
(43) Pub. Date: Nov. 12, 2026

(54) ADHESIVE BACKING DETECTION SYSTEMS AND METHOD

(71) Applicant: Georgia-Pacific Gypsum LLC, Atlanta, GA (US)

(72) Inventors: Sakar T. Chhetri, Stone Mountain, GA (US); Lewis Roger Teeple, III, Savannah, GA (US)

(21) Appl. No.: 19/125,770

(22) PCT Filed: Dec. 12, 2023
(86) PCT No.: PCT/IB2023/062527

§ 371 Date: Apr. 30, 2025

Related U.S. Application Data
(60) Provisional application No. 63/433,023, filed on Dec. 16, 2022.
(60) Provisional application No. 63/544,647, filed on Oct. 18, 2023.

(51) Int. Cl. G05B 19/418; B65H 19/10; B65H 26/02

(52) U.S. Cl. CPC G05B 19/41875; B65H 19/102; B65H 26/02; B65H 2515/60; B65H 2553/414; G05B 2219/32222

(57) ABSTRACT

Systems, apparatuses, methods, computing devices, and/or the like are provided. A system for detecting adhesive backing is provided. The system may include a sensing device including an emitting component and a receiving component, a mounting device configured to operatively connect to the sensing device and align the sensing device with one or more products, a control device configured to be in communication with the sensing device. The emitting component may be configured to emit one or more lights at the one or more products and the receiving component is configured to receive one or more reflections from the one or more products of the one or more emitted lights. The sensing device may, if it detects one or more adhesive backings based on the one or more reflections from the one or more products, send a signal to the control device to cease production of the one or more objects.

### CROSS-REFERENCE TO RELATED APPLICATION

This application claims the benefit of U.S. Provisional Application No. 63/433,023, filed Dec. 16, 2022, and U.S. Provisional Application No. 63/544,647, filed Oct. 18, 2023, both of which are incorporated by reference herein in their entireties.

### TECHNICAL FIELD

The present disclosure relates generally to materials manufacturing, and more particularly to ensuring proper functioning of a paper splicer machine during the manufacturing of gypsum.

### BACKGROUND

During gypsum manufacturing, a paper splicer machine may be used to join together two rolls of paper into a running roll of paper for use in a production line. The paper splicer may use an adhesive (such as tape) for splicing together the rolls of paper. However, tape (or a comparable adhesive) may have a backing that must be removed and, if allowed to remain, may shut down production after the two rolls of paper are spliced together. Stalled production may result in delays and unnecessary cleanup. In gypsum production, stalls in production requires a corresponding restart to the production process, and each startup process may generate its own waste. Hence, a need exists for a reliable means for detecting whether tape has been removed from the paper splicer machine.

Through applied effort, ingenuity, and innovation, the Applicant has solved problems relating to adhesive detection systems and apparatuses used in gypsum manufacturing by developing solutions embodied in the present disclosure, which are described in detail below.

### BRIEF SUMMARY

In general, various embodiments of the present disclosure provide methods, apparatuses, systems, computing devices, computing entities, and/or the like.

In accordance with various embodiments of the present disclosure, A system for detecting adhesive backing is provided. In some embodiments, the system includes a sensing device including an emitting component and a receiving component. In some embodiments, the system includes a mounting device configured to operatively connect to the sensing device and align the sensing device with one or more products. In some embodiments, the system includes a control device configured to be in communication with the sensing device. In some embodiments, the emitting component is configured to emit one or more lights at the one or more products and the receiving component is configured to receive one or more reflections from the one or more products of the one or more emitted lights. In some embodiments, the sensing device is configured to, if it detects one or more adhesive backings based on the one or more reflections from the one or more products, send a signal to the control device to cease production of the one or more objects.

In some embodiments, the sensing device is a color sensor.

In various embodiments, the mounting device is selected from a group consisting of a rail, a robotic arm device, and a gantry.

In various embodiments, the one or more products are selected from a group consisting of: paper, mat, and glass mat.

In some embodiments, the system includes a splicer configured to splice the one or more products, wherein the control device is in communication with the splicer, and wherein the control device is configured to, if it receives the signal from the sensing device to cease production, send a signal to the splicer to cease production.

In some embodiments, the splicer is a paper splicer.

In some embodiments, the system includes a human machine interface, and wherein the control device is configured to, if it receives the signal from the sensing device to cease production, send a signal to the human machine interface instructing an operator to cease production.

In some embodiments, the sensing device is configured to, if it does not detect the one or more adhesive backings, send a signal to the control device to resume production.

In some embodiments, the system includes a second sensing device, wherein the second sensing device includes the emitting component and the first sensing device includes the receiving component, wherein the mounting device is configured to operatively connect the second sensing device, and wherein control device is configured to be in communication with the second sensing device.

In some embodiments, the adhesive backing is a tape backing.

In some embodiments, the system includes one or more connection elements operatively connecting the mounting device to the sensing device, wherein the one or more connection elements are configured to position the sensing device in relation to the mounting device.

According to various embodiments, a method for detecting adhesive backing is provided. In some embodiments, the method includes aligning a sensing device to detect one or more products as it moves into a splicer. In some embodiments, the method includes emitting one or more lights at the one or more products as it moves into the splicer. In some embodiments, the methods includes receiving one or more reflections from the one or more products as it moves into the splicer. In some embodiments, the method includes determining, based on the one or more received reflections, whether or not an adhesive backing has been removed from the one or more products. In some embodiments, if an adhesive backing has been detected, the method includes transmitting a signal to the splicer to cease production.

In some embodiments, the sensing device is a color sensor.

In various embodiments, the mounting device is selected from a group consisting of a rail, a robotic arm device, and a gantry.

In various embodiments, the one or more products are selected from a group consisting of: paper, mat, and glass mat.

In some embodiments, the splicer is a paper splicer.

In some embodiments, the adhesive backing is a tape backing.

According to various embodiments, there is provided a system for detecting adhesive backing, the system including: a sensing device comprising a receiving component; a mounting device configured to operatively connect to the sensing device and align the sensing device with one or more products; a control device configured to be in communication with the sensing device; and a light emitting component directed toward the one or more products, wherein the receiving component is configured to receive one or more reflections from the one or more products of the light emitting component, wherein the sensing device is configured to, if it detects one or more adhesive backings based on the one or more reflections from the one or more products, send a signal to the control device to cease production of the one or more objects.

In some embodiments, the light emitting component is disposed externally to one or more of the sensing device, the mounting device, and the control device.

In some embodiments, the light emitting component is ambient light.

The above summary is provided merely for purposes of summarizing some example various embodiments to provide a basic understanding of some embodiments of the disclosure. Accordingly, it will be appreciated that the above-described various embodiments are merely examples. It will be appreciated that the scope of the disclosure encompasses many potential various embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is diagram illustrating example architecture for an example control device in accordance with various embodiments of the present disclosure;

FIG. 2 is a schematic of an example management computing entity for an example control device in accordance with various embodiments of the present disclosure;

FIG. 3 is a schematic of an example user computing entity for an example control device in accordance with various embodiments of the present disclosure;

FIG. 4 is an angled view of an example system in accordance with various embodiments of the present disclosure;

FIG. 5 is an angled view of an example system and an example splicer in accordance with various embodiments of the present disclosure;

FIG. 6 is an angled view of an example system, splicer, and product in accordance with various embodiments of the present disclosure;

FIG. 7A is a first angled view of an example detection system in operation in accordance with various embodiments of the present disclosure;

FIG. 7B is a second angled view of an example detection system in operation in accordance with various embodiments of the present disclosure; and

FIG. 8 is a flow chart illustrating an example method of making using an example automated edge forming system in accordance with various embodiments of the present disclosure.

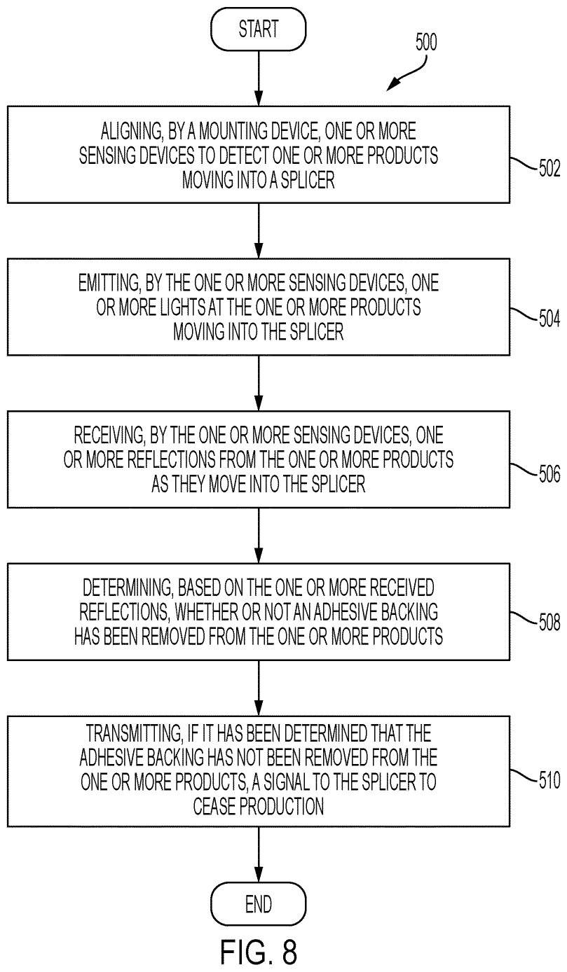

### DETAILED DESCRIPTION OF SOME EXAMPLE VARIOUS EMBODIMENTS

Various embodiments of the present disclosure now will be described more fully hereinafter with reference to the accompanying drawings, in which some, but not all various embodiments of the disclosure are shown. Indeed, this disclosure may be embodied in many different forms and should not be construed as limited to the various embodiments set forth herein; rather, these various embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

Various embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

As should be appreciated, various embodiments of the present disclosure may also be implemented as methods, apparatuses, systems, computing devices, computing entities, and/or the like. As such, various embodiments of the present disclosure may take the form of a data structure, apparatus, system, computing device, computing entity, and/or the like executing instructions stored on a computer-readable storage medium to perform certain steps or operations. Thus, various embodiments of the present disclosure may also take the form of an entirely hardware embodiment, an entirely computer program product embodiment, and/or an embodiment that comprises combination of computer program products and hardware performing certain steps or operations.

Various embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary various embodiments, retrieval, loading, and/or execution may be performed in parallel such that multiple instructions are retrieved, loaded, and/or executed together. Thus, such various embodiments can produce specifically-configured machines performing the steps or operations specified in the block diagrams and flowchart illustrations. Accordingly, the block diagrams and flowchart illustrations support various combinations of various embodiments for performing the specified instructions, operations, or steps.

### Computer Program Products, Systems, Methods, and Computing Entities

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially, such that one instruction is retrieved, loaded, and executed at a time. In some exemplary embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

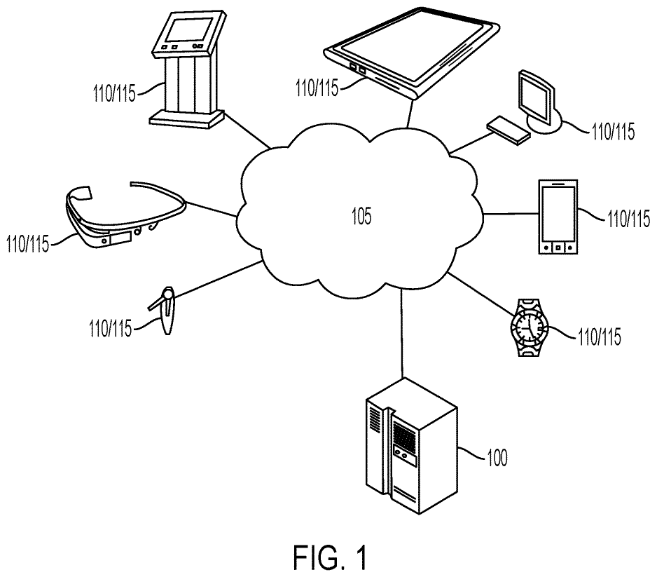

FIG. 1 provides an illustration of an exemplary system architecture that may be used in accordance with various embodiments of the present disclosure. As shown in FIG. 1, the architecture may include one or more management computing entities 100, one or more networks 105, and one or more user computing entities 110. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### Exemplary Management Computing Entity

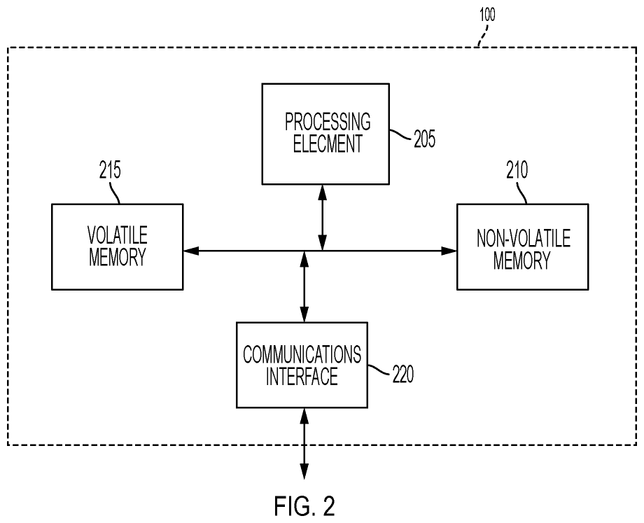

FIG. 2 provides a schematic of a management computing entity 100 according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the management computing entity 100 may communicate with user computing entities 110 and/or a variety of other computing entities.

As shown in FIG. 2, in one embodiment, the management computing entity 100 may include or be in communication with one or more processing elements 205 (also referred to as processors, processing circuitry, and/or similar terms used herein interchangeably) that communicate with other elements within the management computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the management computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity 100 with the assistance of the processing element 205 and operating system.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1×(1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity 100 may include or be in communication with one or more input elements, such as a keyboard input, a mouse input, a touch screen/display input, motion input, movement input, audio input, pointing device input, joystick input, keypad input, and/or the like. The management computing entity 100 may also include or be in communication with one or more output elements (not shown), such as audio output, video output, screen/display output, motion output, movement output, and/or the like.

As will be appreciated, one or more of the management computing entity's 100 components may be located remotely from other management computing entity 100 components, such as in a distributed system. Furthermore, one or more of the components may be combined and additional components performing functions described herein may be included in the management computing entity 100. Thus, the management computing entity 100 can be adapted to accommodate a variety of needs and circumstances. As will be recognized, these architectures and descriptions are provided for exemplary purposes only and are not limiting to the various embodiments.

### Exemplary User Computing Entity

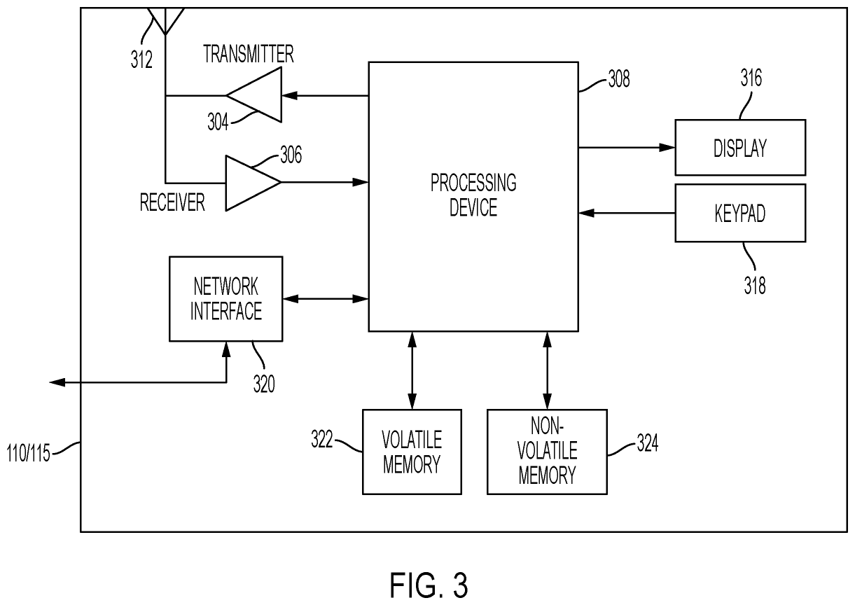

A user may be an individual, a family, a company, an organization, an entity, a department within an organization, a representative of an organization and/or person, and/or the like. To do so, a user may operate a user computing entity 110 that includes one or more components that are functionally similar to those of the management computing entity 100. FIG. 3 provides an illustrative schematic representative of a user computing entity 110 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 110 can be operated by various parties. As shown in FIG. 3, the user computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 110 may be capable of operating with one or more air interface standards, communication protocols, modulation types, and access types. More particularly, the user computing entity 110 may operate in accordance with any of a number of wireless communication standards and protocols, such as those described above with regard to the management computing entity 100. In a particular embodiment, the user computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 110 may operate in accordance with multiple wired communication standards and protocols, such as those described above with regard to the management computing entity 100 via a network interface 320.

Via these communication standards and protocols, the user computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 110 can also download changes, add-ons, and updates, for instance, to its firmware, software (e.g., including executable instructions, applications, program modules), and operating system.

According to one embodiment, the user computing entity 110 may include location determining aspects, devices, modules, functionalities, and/or similar words used herein interchangeably. For example, the user computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 110 position in connection with a variety of other systems, including cellular towers, Wi-Fi access points, and/or the like. Similarly, the user computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 110 may also comprise an IETM viewer (that can include a display 316 coupled to a processing element 308) and/or a viewer (coupled to a processing element 308). For example, the IETM viewer may be a user application, browser, user interface, graphical user interface, and/or similar words used herein interchangeably executing on and/or accessible via the user computing entity 110 to interact with and/or cause display of information from the management computing entity 100, as described herein. The term “viewer” is used generically and is not limited to “viewing.” Rather, the viewer is a multi-purpose digital data viewer capable and/or receiving input and providing output. The viewer can comprise any of a number of devices or interfaces allowing the user computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 110 and may include a full set of alphabetic keys or set of keys that may be activated to provide a full set of alphanumeric keys. In addition to providing input, the viewer can be used, for example, to activate or deactivate certain functions, such as screen savers and/or sleep modes.

The user computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 110. As indicated, this may include a user application that is resident on the entity or accessible through a browser or other IETM viewer for communicating with the management computing entity 100 and/or various other computing entities.

In some embodiments, the user computing entity 110 may include one or more components or functionality that are the same or similar to those of the management computing entity 100, as described in greater detail above. As will be recognized, these architectures and descriptions are provided for exemplary purposes only and are not limiting to the various embodiments.

### Exemplary System Operations

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. Greater or fewer operations may be performed than shown in the figures and described herein. These operations may also be performed in a different order than those described herein.

As described above, the management computing entity 100 and/or user computing entity 110 may be configured for storing technical documentation (e.g., data) in an IETM, providing access to the technical documentation to a user via the IETM, and/or providing functionality to the user accessing the technical documentation via the IETM. In general, the technical documentation is typically made up of volumes of text along with other media objects. In many instances, the technical documentation is arranged to provide the text and/or the media objects on an item. For instance, the item may be a product, machinery, equipment, a system, and/or the like such as, for example, a bicycle or an aircraft.

Accordingly, the technical documentation may provide textual information along with non-textual information (e.g., one or more visual representations) of the item and/or components of the item. Textual information generally includes alphanumeric information and may also include different element types such as graphical features, controls, and/or the like. Non-textual information generally includes media content such as illustrations (e.g., 2D and 3D graphics), video, audio, and/or the like. Although the non-textual information may also include alphanumeric information.

The technical documentation may be provided as digital media in any of a variety of formats, such as JPEG, JFIF, JPEG2000, EXIF, TIFF, RAW, DIV, GIF, BMP, PNG, PPM, MOV, AVI, MP4, MKV, and/or the like. In addition, the technical documentation may be provided in any of a variety of formats, such as DOCX, HTMLS, TXT, PDF, XML, SGML, JSON and/or the like. As noted, the technical documentation may provide textual and non-textual information of various components of the item. For example, various information may be provided with respect to assemblies, sub-assemblies, sub-sub-assemblies, systems, subsystems, sub-subsystems, individual parts, and/or the like associated with the item.

In various embodiments, the technical documentation for the item may be stored and/or provided in accordance with S1000D standards and/or a variety of other standards. According to various embodiments, the management computing entity 100 and/or user computing entity 110 provides functionality in the access and use of the technical documentation provided via the IETM in accordance with user instructions and/or input received from the user via an IETM viewer (e.g., a browser, a window, an application, a graphical user interface, and/or the like).

Accordingly, in particular embodiments, the IETM viewer is accessible from a user computing entity 110 that may or may not be in communication with the management computing entity 100. For example, a user may sign into the management computing entity 100 from the user computing entity 110 or solely into the user computing entity 110 to access technical documentation via the IETM and the management computing entity 100 and/or user computing entity 110 may be configured to recognize any such sign in request, verify the user has permission to access the technical documentation (e.g., by verifying the user's credentials), and present/provide the user with various displays of content for the technical documentation via the IETM viewer (e.g., displayed on display 316).

Further detail is now provided with respect to various functionality provided by embodiments of the present disclosure. As one of ordinary skill in the art will understand in light of this disclosure. The modules now discussed and configured for carrying out various functionality may be invoked, executed, and/or the like by the management computing entity 100, the user computing entity 110, and/or a combination thereof depending on the embodiment.

### Example Adhesive Detection System, Method, and Apparatus

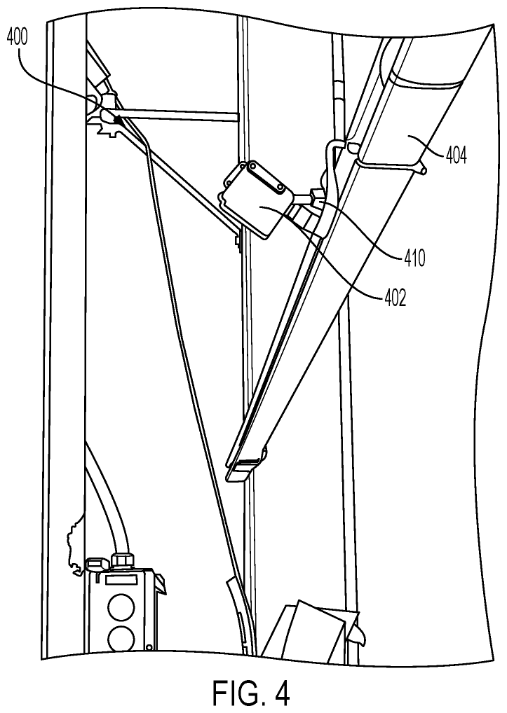

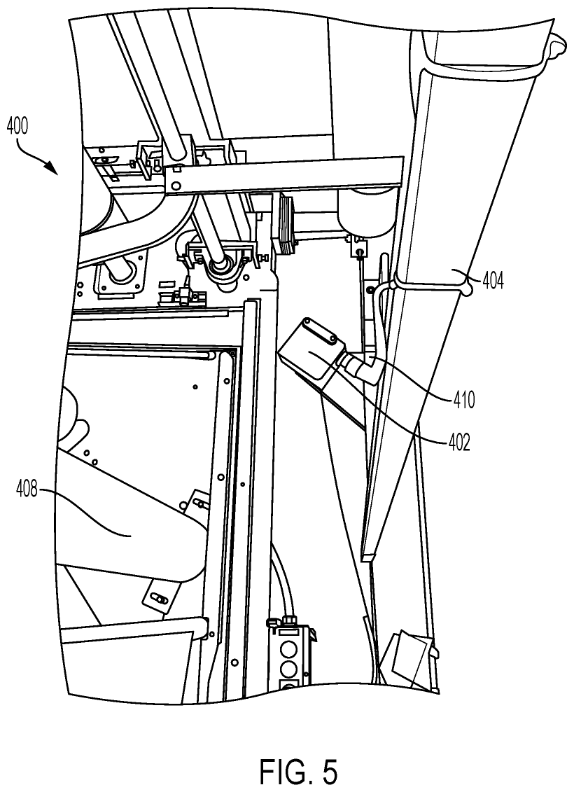

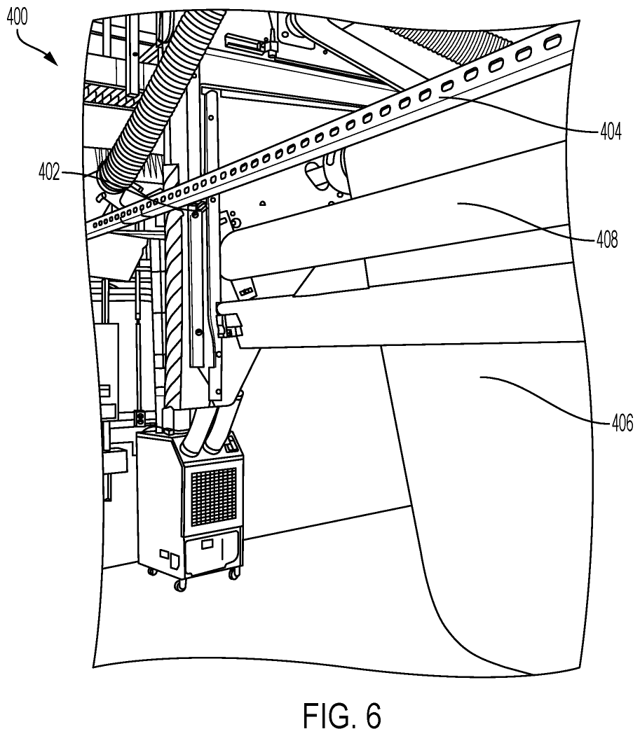

FIGS. 4, 5, and 6 show example views of an adhesive detection system 400, according to some embodiments. In some embodiments, the system 400 may include a sensing device 402. In some embodiments, the sensing device 402 may be directed at a paper splicer machine, particularly at the location where rolls of paper are inserted into the head of the splicer machine's to be spliced together. In some embodiments, and as will be explained in greater detail later in this disclosure, the sensing device 402 may be configured to detect whether an adhesive backing has been removed from one or more products before the one or more products are spliced together. In some embodiments, the product may be paper or mat. In some embodiments, the product may be paper used in gypsum manufacturing. In some embodiments, if the sensing device 402 detects that the adhesive backing has not been removed, the sensing device 402 may be configured to send a signal to one of the control devices previously disclosed. In some embodiments, one of the control devices may then send a signal to the paper splicer to cease operation until the backing has been removed from the adhesive. In at least this way, the sensing device 402 may prevent adhesive backing from entering the paper splicer, which may potentially damage the machine and/or require a stall in production.

During an example splicing operation, a roll of paper is placed between two or more arms of the paper splicer machine, and an operator ensures that the roll is at the center and, if necessary, manually trims the excess materials from the roll. The operator takes the end of the mat, clamps the end of the roll on the Web Bar. The two-sided tape is applied, and the adhesive backing is removed before the Web Bar is sent back to the splice head to be ready for the splice. If the adhesive backing is not removed, the splice will not be complete as the paper/mat will not slice with the existing roll causing downtime.

In some embodiments, referring to FIGS. 4-6, the sensing device 402 may be mounted on a mounting device such as a rail 404. In some embodiments, the sensing device 402 and rail 404 may be positioned such that the sensing device 402 detects the back of a product 406 as it enters a splicer machine 408. In some embodiments, the splicer machine may be a paper splicer or a glass mat splicer. In some embodiments, a connection element 410 may operably connect the sensing device 402 to the rail 404. The connection element 410 may consist of various components for securing the sensing device 402 to the rail 404, such as a bracketing and a gimbal. In some embodiments, the connection element 410 may be configured to reposition the sensing device 402 as needed (e.g., by means of an actuator). It will be understood that the sensing device 402 may be operatively connected directly to the mounting device 404 (e.g., directly to the rail). It will also be understood that other mounting devices besides a rail 404 may be used to mount and position the sensing device 402 to be directed at the product 406. For example, in some embodiments, a gantry or a robotic arm device may be used to position the sensing device 402. In some embodiments, a mounting device (such as a robotic arm) may be controlled by one of the control devices previously described in this disclosure. In some embodiments, the control device may control the robotic arm to position the sensing device 402. In some embodiments, an operator may manually position the sensing device 402 and/or the mounting device 404.

In some embodiments, the sensing device 402 may include an emitting component and a receiving component. In some embodiments, the emitting component may be a light emitting component, and the receiving component may be a light receiving component. In some embodiments, the light emitting component may be configured to emit light, and the light receiving component may be configured to receive a reflection of the light. In some embodiments, during operation, the sensing device 402 may use its emitting component to emit light at a product as it is being inserted into a splicer (e.g., rolls of paper being inserted into a paper splicer). The sensing device 402 may then receive at its receiving component a reflection of that light from the product. If the sensing device 402 receives in its receiving component a reflection of light indicating that the adhesive backing has not been removed, then the sensing device may be configured to inform a control device and/or a technician that the adhesive backing has not been removed. In some embodiments, the sensing device 402 may include a communications interface configured to connect with a network and/or one or more control devices (as previously described in the disclosure). In some embodiments, the sensing device 402 may include a memory component to store, either in the short-term or long-term, the reflection received from the emitted light. In some embodiments, the sensing device 402 may send the received signal directly to a control device, and the control device may determine whether an adhesive backing has been detected. In some embodiments, the emitting and receiving component may each be housed within a single sensing device 402, while in some embodiments, the emitting and receiving components may be separate.

In some embodiments, to emit light, the sensing device 402 may use a light source that is external to the adhesive detection system 400 and/or the sensing device 402. In some embodiments, the light source may be ambient light, which may also be external to the adhesive detection system 400.

In some embodiments, the sensing device 402 may be a photoelectric sensing device. In some embodiments, the sensing device 402 may be a color sensing device, such as a Keyence color LR-W500C sensing device. In some embodiments, the sensing device 402 may be a camera, such as a Cognex Camera (e.g., an “Insight 2000” camera) or a Teledyne Dalsa “Genie Nano M2020 Mono” camera.

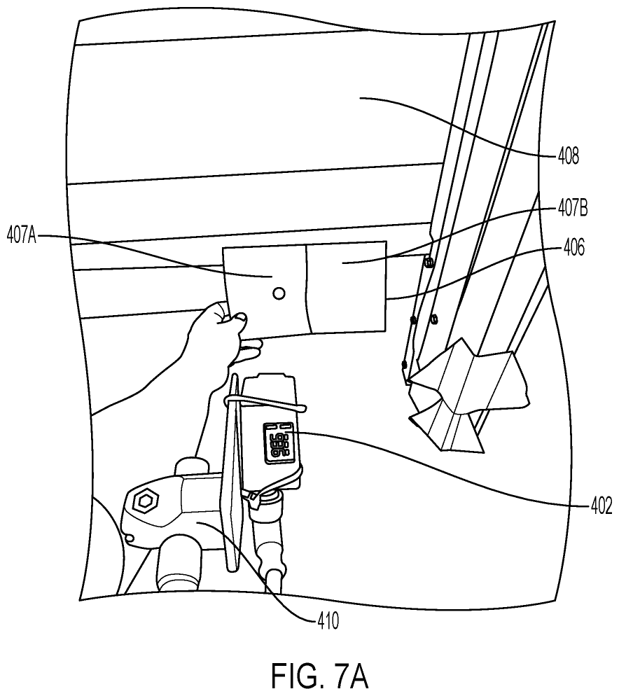

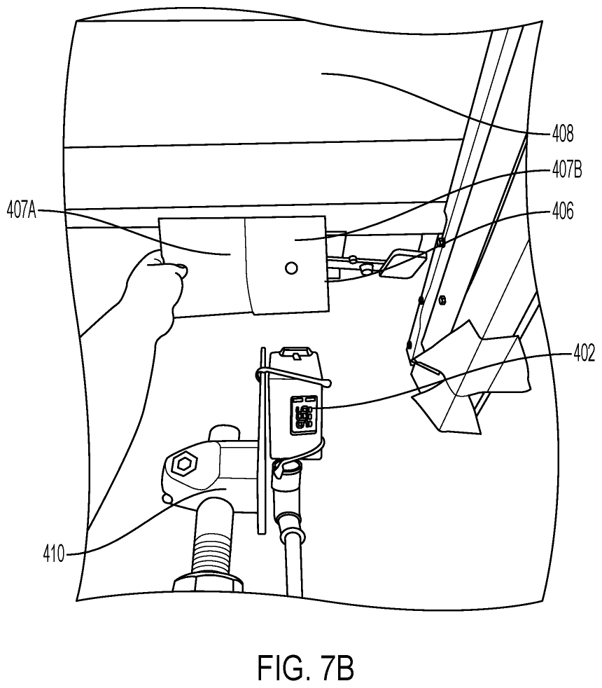

Operation of the sensing device 402 is shown in at least FIGS. 7A and 7B, according to some embodiments. As shown in FIG. 7A, the sensing device 402 is detecting a piece of white glass mat product 406 on the side 407A with the backing of the adhesive removed. In this instance, the sensing device 402 would either not send a signal to the control device or, in some embodiments, send a signal to the control device that there is no need to stop production because the backing of the adhesive has been removed. In some embodiments, as shown in FIG. 7B, the sensing device 402 is detecting a piece of white glass mat product 406 on the side 407B with the backing of the adhesive not removed. In this instance, the sensing device 402 would send a signal to the control device that production should stop to prevent the back of the adhesive from entering the splicer. In some embodiments, the signal may appear on a human machine interface to notify an operator to stop production. An operator could then remove the backing of the adhesive and resume production. In some embodiments, the sensing device 402 may be calibrated to detect different backing of different adhesives. In some embodiments, the sensing device 402 may be calibrated to detect different materials being fed into a paper splicer machine. In some embodiments, calibration may be performed by a technician or by a machine-learning algorithm. In some embodiments, the sensing device 402 may calibrate and re-calibrate during production to detect when adhesive backing has not been removed from a product. In some embodiments, more than one sensing device may be used to detect the backing of different adhesives. In some embodiments, the sensing device may be configured to, upon detecting that there is no adhesive backing remaining on the product, send a signal to resume production. In some embodiments, the sensing device 402 may be configured to detect product defects, in addition to detecting when adhesive backing has not been removed.

In some embodiments, the system 400 may interact with one or more other systems on a production line. For example, in some embodiments, the system 400 may interact with an edge alignment system for use during gypsum production. In some embodiments, the system 400 may interact with a paper tear vision system for use during gypsum production. In some embodiments, the one or more control devices of the system 400 may be the same as or interact with one or more control devices of the other systems in gypsum production. For example, if the system 400 detects that adhesive backing has not been removed from one or more products, then the system 400 may cascade a signal down the production line for other systems to also cease operation while the adhesive backing is removed from the product.

A method of operation 500 will now be described for using a tape detection system. The method 500 is described in reference to the previously described system 400 and the one or more control devices previously disclosed. However, it will be understood that the method 500 may be implemented by a variety of suitable systems and apparatuses. In some embodiments, the method 500 may include a step 502 of aligning a sensing device to detect one or more products as it moves into a splicer. In some embodiments, the method 500 may include a step 504 of emitting one or more lights at the one or more products as it moves into the splicer. In some embodiments, the method 500 may include a step 506 of receiving one or more reflections from the one or more products as it moves into the splicer. In some embodiments, the method 500 may include a step 508 of determining, based on the one or more received reflections, whether or not an adhesive backing has been removed from the one or more products. In further embodiments, the method 500 may include a step 510 of, transmitting, if it has been determined that the adhesive backing has not been removed from the one or more products, a signal to the splicer to cease production. It will be understood that, in some embodiments, the method may include additional or alternative steps. For example, in some embodiments, the sensing device may transmit the signal to one or more control devices, and then the one or more control devices may give the signal to cease production. In some embodiments, the sensing device (or control device) may transmit a signal to resume production once it detects that the adhesive backing has been removed from the one or more products.

### CONCLUSION

Many modifications and other various embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific various embodiments disclosed and that modifications and other various embodiments are intended to be included within the scope of the appended claims. Although specific terms are employed herein, they are used in a generic and descriptive sense only and not for purposes of limitation.

1. A system for detecting adhesive backing, the system comprising:
a sensing device comprising an emitting component and a receiving component;
a mounting device configured to operatively connect to the sensing device and align the sensing device with one or more products;
a control device configured to be in communication with the sensing device, wherein the emitting component is configured to emit one or more lights at the one or more products and wherein the receiving component is configured to receive one or more reflections from the one or more products of the one or more emitted lights, and
wherein the sensing device is configured to, if it detects one or more adhesive backings based on the one or more reflections from the one or more products, send a signal to the control device to cease production of the one or more objects.

2. The system of claim 1, wherein the sensing device is a color sensor.

3. The system of claim 1, wherein the mounting device is selected from a group consisting of: a rail, a robotic arm device, and a gantry.

4. The system of claim 1, wherein the one or more products are selected from a group consisting of: paper, mat, and glass mat.

5. The system of claim 1, further comprising a splicer configured to splice the one or more products, wherein the control device is in communication with the splicer, and wherein the control device is configured to, if it receives the signal from the sensing device to cease production, send a signal to the splicer to cease production.

6. The system of claim 5, wherein the splicer is a paper splicer.

7. The system of claim 1, further comprising a human machine interface, and wherein the control device is configured to, if it receives the signal from the sensing device to cease production, send a signal to the human machine interface instructing an operator to cease production.

8. The system of claim 1, wherein the sensing device is configured to, if it does not detect the one or more adhesive backings, send a signal to the control device to resume production.

9. The system of claim 1, comprising a second sensing device, wherein the second sensing device comprises the emitting component and the first sensing device comprises the receiving component, wherein the mounting device is configured to operatively connect to the second sensing device, and wherein control device is configured to be in communication with the second sensing device.

10. The system of claim 1, wherein the adhesive backing is a tape backing.

11. The system of claim 1, further comprising one or more connection elements operatively connecting the mounting device to the sensing device, wherein the one or more connection elements are configured to position the sensing device in relation to the mounting device.

12. A method for detecting adhesive backing, the method comprising:
aligning a sensing device to detect one or more products as it moves into a splicer;
emitting one or more lights at the one or more products as it moves into the splicer;
receiving one or more reflections from the one or more products as it moves into the splicer;
determining, based on the one or more received reflections, whether or not an adhesive backing has been removed from the one or more products; and
transmitting, if it has been determined that the adhesive backing has not been removed from the one or more products, a signal to the splicer to cease production.

13. The method of claim 12, wherein the sensing device is a color sensor.

14. The method of claim 12, wherein the mounting device is selected from a group consisting of: a rail, a robotic arm device, and a gantry.

15. The method of claim 12, wherein the one or more products are selected from a group consisting of: paper, mat, and glass mat.

16. The method of claim 12, wherein the splicer is a paper splicer.

17. The method of claim 12, wherein the adhesive backing is a tape backing.

18. A system for detecting adhesive backing, the system comprising:
a sensing device comprising a receiving component;
a mounting device configured to operatively connect to the sensing device and align the sensing device with one or more products;
a control device configured to be in communication with the sensing device; and
a light emitting component directed toward the one or more products, wherein the receiving component is configured to receive one or more reflections from the one or more products of the light emitting component, wherein the sensing device is configured to, if it detects one or more adhesive backings based on the one or more reflections from the one or more products, send a signal to the control device to cease production of the one or more objects.

19. The system of claim 18, wherein the light emitting component is disposed externally to one or more of the sensing device, the mounting device, and the control device.

20. The system of claim 18, wherein the light emitting component comprises ambient light.
